(19) United States
(12) Patent Application Publication
(10) Pub. No.: US 2015/0282254 A1
(43) Pub. Date: Oct. 1, 2015

(54) HEATING DEVICE FOR A VEHICULAR SIDE MIRROR

(71) Applicant: SMR Patents S.a.r.l., Luxembourg (LU)

(72) Inventor: Daniel Fritz, Stuttgart (DE)

(21) Appl. No.: 14/734,562

(22) Filed: Jun. 9, 2015

Related U.S. Application Data
(63) Continuation of application No. 13/154,961, filed on Jun. 7, 2011.

(30) Foreign Application Priority Data
Jun. 7, 2010 (EP) 10165071.1

(51) Int. Cl. H05B 3/84; B60S 1/02; B60R 1/06; H05B 1/02

(52) U.S. Cl. CPC H05B 3/845; H05B 1/0236; B60S 1/026; B60R 1/0602

(57) ABSTRACT

An exterior rear view mirror assembly for a motor vehicle includes a mirror bracket secured to the motor vehicle. A mirror housing is secured to the mirror bracket and defines a primary opening facing rearward. A substrate is movably secured therewithin. A mirror is secured to the substrate and is movable therewith. A heating device having a heatable element is disposed between the substrate and the mirror. The heating device has a contact that is electrically connected to electrical contacts of the power supply of the motor vehicle. The heating device is divided into first and second regions, which are subjected to different heating output or different heat release over time.

This is a continuation of a United States patent application having application Ser. No. 13/154,961, filed Jun. 7, 2011, and claims priority to European patent application EP10165071.1 which is hereby incorporated by reference.

### BACKGROUND ART

1. Field of the Invention

The invention relates to a heating device for a mirror glass of a mirror, particularly an exterior mirror for a motor vehicle, whereby a heating device is applied on a substrate, as well as a process for production of a mirror of this type.

2. Description of the Related Art

In EP 0 732 865 B 1, a heating device is known, which is formed by carbon fibers, which are conductively connected to each other by a binding agent. A mirror glass is applied on a backing plate for the mirror glass by a bonding layer.

Furthermore, it is known to directly apply a heating installation on the rear side on the mirror glass of a mirror by a screen printing method or similar. As disclosed in FR 2 628 041, however, the reflective layer is then installed on the mirror on the external side, with increased risk of damage to the reflective layer. In addition, in the known process, the conductive paste is cured at a temperature of approximately 670°, which can cause problems in maintaining the bending accuracy in spherical and aspherical mirror pieces.

Alongside, it is also known from DE 10 2004 002 979 A1 to design the rear sided reflective layer on a mirror glass directly as a heating layer.

However, in the process, problems occur in equal distribution of the current flow in the thin reflective layer, as well as maintaining electrical contact with a source of power.

DE 42 23 590 A1 shows a mirror, in which a transparent heating device is attached as an ITO layer on the front side of the mirror glass, which is covered by a protective layer, which is applied by sputtering or by plasma deposition, for example. In this arrangement, the known problems exist in the contacting of thin layers. Additionally, the ITO layer is very sensitive to damages, which can lead to local ‘hot spots.’

Furthermore, FR 2 618 396 A1 describes a backing foil for a mirror glass with a heating device applied by screen printing. On the front side of the heating device turned towards the mirror glass, a secure connection between the mirror glass and backing foil is produced by double-sided tape. In addition, the heating device is sealed through the double-sided tape.

Furthermore it is known, in general, to produce resistance heating for a mirror glass in the form of a laminated copper foil in a photo etching process, and, subsequently, to attach the copper foil onto the backing plate with double-sided tape.

It is common to the whole prior art that equal heating should be achieved over the whole mirror glass. Hot spots should be avoided in the process, and, of course, current peaks in the heating cables, in order to avoid a burn-out of the heating cables or evaporation of the heating layer.

U.S. Pat. No. 5,610,756 discusses mirror heating for an electrochromatic mirror. In order to optimally operate this mirror, two different modes are provided for the heating installation. A first state quickly heats a core area, in order to defrost the mirror. In the second mode, the whole surface is heated, in order to guarantee an optimal operating temperature for the electrochemical process.

The EP0112930 shows a heatable rear window with a filament, which runs in the form of a logo.

U.S. Pat. No. 4,251,316 shows a heatable exterior mirror, in which a logo is formed in one surface insulated against the heating.

### SUMMARY OF THE INVENTION

The object of the invention is to provide a heating device for a mirror glass of a mirror, in particular, an exterior mirror of a motor vehicle, which provides an uneven heating output, and facilitates the appearance of a sign or logo, e.g., the logo of the manufacturer of the vehicle during the defrosting or demisting process.

This object is achieved by a heating device with the features to distribute the surface to be heated in at least two regions, and to load the at least two regions with different heating output or a different temporal heat release.

In the process, the production of the heating layer can take place with all known procedures.

The invention is explained with the example of a conventional adhesive foil with heating cables.

The known production of resistance heating from a laminated copper foil in a photo etching process resulted in a flexible foil, which is subsequently attached with double-sided tape on the rear side of the mirror. In the process, the heating cables comprise the same distances, thicknesses and widths, so that the applied voltage results in a current flow, which is as equal as possible.

### BRIEF DESCRIPTION OF THE DRAWINGS

Advantages of the invention will be readily appreciated as the same becomes better understood by reference to the following detailed description when considered in connection with the accompanying drawings, wherein:

FIG. 1 shows a heating foil of the prior art;

FIG. 2 shows a top view of heating foil according to the invention;

FIGS. 3 and 3A show second and third embodiments of the invention;

FIG. 4 shows a third coated embodiment;

FIG. 5 shows a perspective view, partially cut away, of the invention incorporated into a mirror assembly of the motor vehicle;

FIG. 6 shows a perspective view, partially cut away, of the invention incorporated into a mirror assembly of a motor vehicle with the mirror glass covered with condensation; and

FIG. 7 shows a perspective view, partially cut away of the invention incorporated into a mirror assembly of a motor vehicle with the condensation removed from a second region.

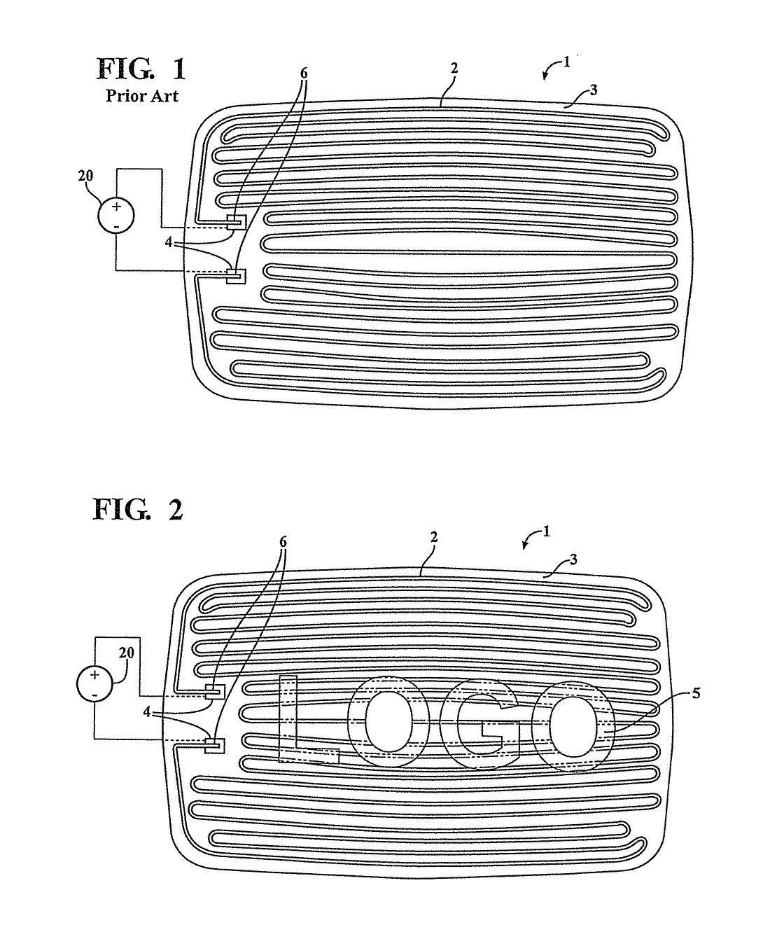

### DETAILED DESCRIPTION OF THE PREFERRED EMBODIMENTS

A backing plate 1 for a mirror 10 shown in more detail in FIGS. 5 through 7, particularly an exterior mirror 10 for a motor vehicle 12, includes a surface 3 turned towards a mirror glass 14, which is visible through a primary opening 16 in a mirror housing 18 and faces rearward with respect to the forward motion of the motor vehicle 12. The mirror housing 18 is movably secured to the motor vehicle 12 via a bracket 19. The surface 3 is part of the heating device and is provided with a meandering conducting path 2. The surface 3 describes a first region of the backing plate without foil, which is heated. The ends 6 of the conducting path 2 are led through on one side of the surface 3, and soldered with angular contacts 4.

The backing plate 1 consists of a plastic material and is stamped from a film, or is produced in an injection molding process, in another design. All types of plastic, which can be manipulated in an injection molding process, are suitable as material for the backing plate 1.

The conducting path 2 is sprayed on meandering in a variety of loops on the front side of the surface 3. The available surface of the backing plate 1 plays a role, inter alia, in selection of resistance materials. In order to achieve a heater current of 2 amps, in vehicle voltage of 12 volts, and thus an electrical output of 24 watts, a cross-sectional surface of the conducting path 2 of 0.2 mm², and a desired resistance of 6 Ohm, is taken as the starting point.

The heating device (conducting path 2) is powered by a power supply 20 (graphically represented in FIG. 2) that powers the motor vehicle 12 (typically a vehicular battery) and its heating output are measured in such a way that a quick and equal heating of the mirror glass 14 removes condensation 22 either in liquid or solid, e.g. frost or ice, by providing enough thermal energy to the mirror glass 14 to convert the liquid or solid condensation 22 to gas.

As shown in FIGS. 2, 5 and 7 the heating device 2 is modified in such a way that during defrosting of the mirror, a sign or logo appears in a second region 5. The second region 5 includes the surface, which is formed by the letters or signs of a logo. For this purpose, the cross-sectional surfaces of the heating element 2 are reduced by a length; which corresponds to the diameter of the logo. The resistance, and thus the heating current, also increase locally due to the tapering of the cross-section. Through this, a higher heating output is achieved locally in the region of the dimensions of the logo. The mirror to be defrosted is therefore defrosted first of all in the region of the logo, with the structure appearing whilst the rest of the mirror is still iced over or misted. The whole mirror is mist-free within the time desired by the manufacturer.

Alternatively, the application can be in inverse form, in which the second region 5 of the logo receives less heating output, and therefore remains as an iced over or misted structure, before it defrosts in the nominal time frame. In one instance, the application of material to create the conducting path 2 may be completely eliminated.

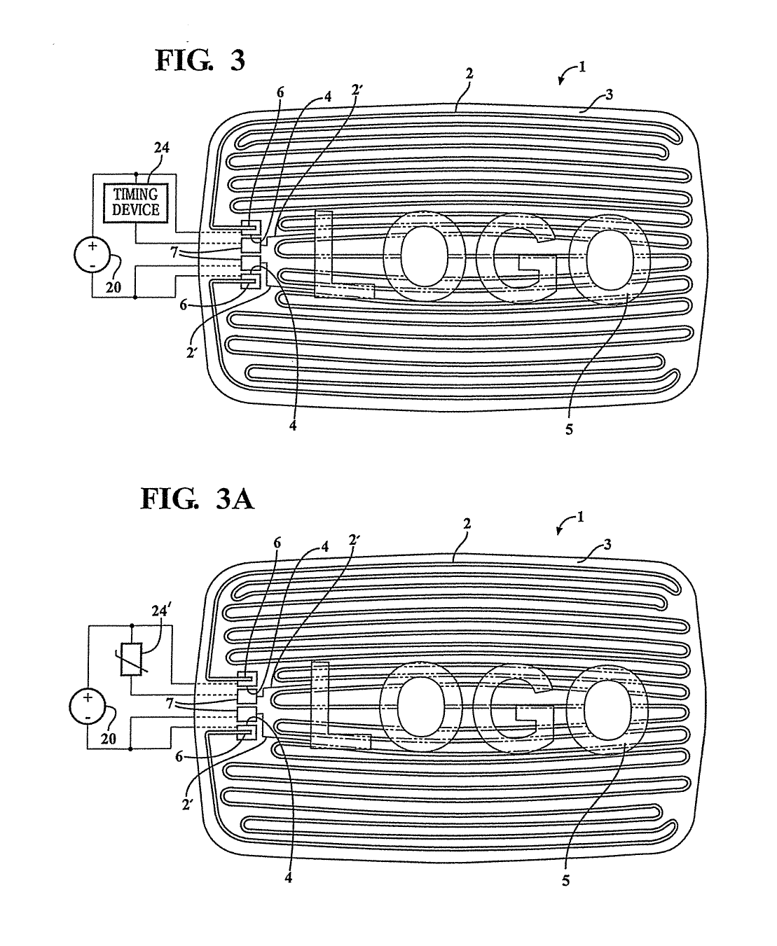

Differing from the execution example shown, two or several separate heating circuits with conducting paths 2, 2′ and contact pairs 4 and 7, electrically separated from each other, can be provided, as shown in FIG. 3. In this embodiment, the targeted conducting paths 2, 2′ separately control the two regions in this heating unit. The layout of two separate heating circuits simplifies the layout of the whole heating element. No transitions need to be provided between different cross-sections of the heating conductor. The risk of burn-out is reduced.

A further embodiment is achieved with the use of two separate heating circuits. The heating wires of a heating circuit are positioned in the process along the contour of a logo or sign. The logo is thus directly defrosted. Above all, this embodiment is suitable for logos which do not have radii which are too narrow, so that the current flow must not be led through these narrow radii in the heating conductor.

A solution is also possible with two separate heating circuits, which control a heating circuit, first of all, and the second heating circuit with a time device, graphically represented by 24 in FIG. 3. The timing device 24 creates a time lag or delay. With this timed solution, total defrosting is achieved in the desired frame, and the layout of the heating circuit is optimized. In one embodiment, the delay device 24 is a switching mechanism with a timing relay.

The timing device 24 may also be a thermistor 24′ (shown in FIG. 3A). If the first section of the mirror glass 14 and thus the thermistor 24′ warms up, it connects the second heating circuit 2′ for this purpose. Therefore, a temperature-controlled, timed solution is given for both heating zones. For this solution, the circuit of the heating installation is to be attached on the surface to be heated, since the surface temperature controls the thermistor 24′.

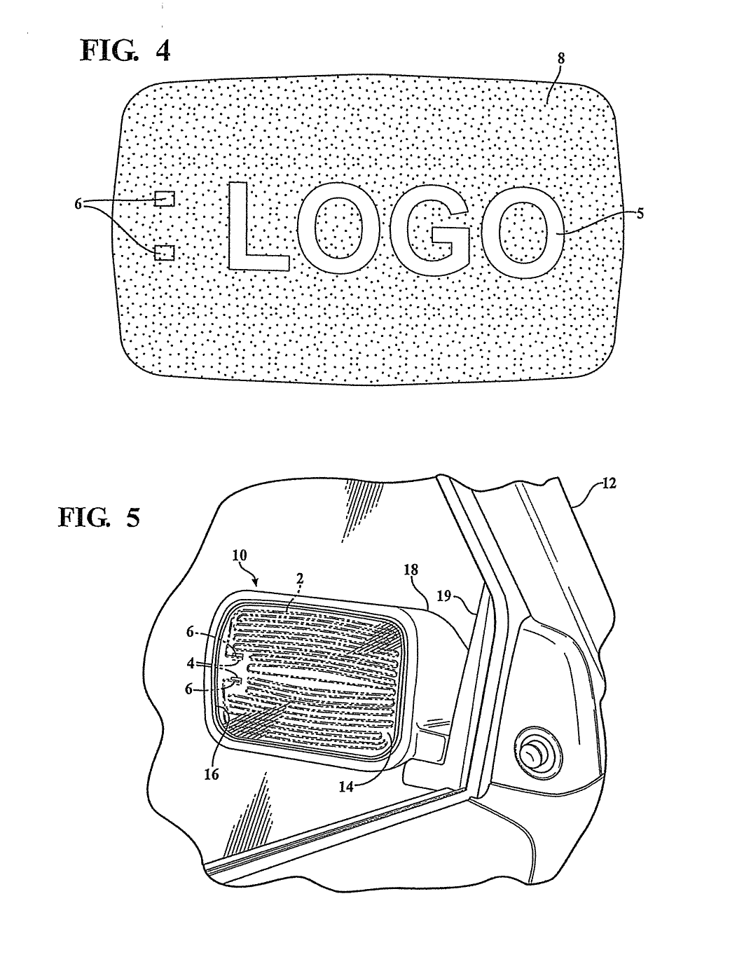

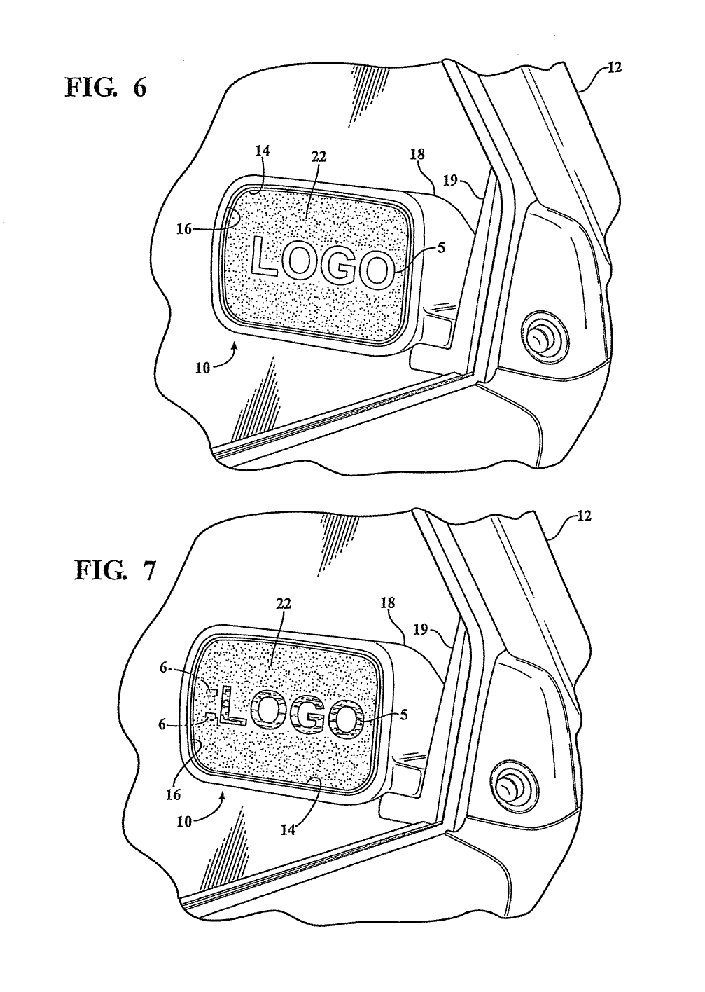

FIGS. 4 and 6 show an embodiment, which works with a flat coating for heating a mirror. The second region 5 of the logo is exempt from the flat coating 8. The rest of the coating must be laid out so that despite the recesses, a homogenous current flow is guaranteed, and the omitted surfaces are equally defrosted by heat conduction within the desired time frame.

If a flat coating 8 is chosen, a structuring, e.g. meandering heat conductors, with a laser is possible. The structuring with a laser also facilitates the simplified creation of a logo in the conductive layer. Through the choice of the laser output, together with the writing speed, allows a partial removal of the conductive layer in the region of the logo to be achieved, so that in this region more heating occurs due to the higher resistance.

Alternatively, the application of the heating conductors can take place with different spraying processes.

In an arc spraying process, an arc between two filamentary spraying additions of the same or different compositions is used in order to melt the wire tips. The melted material is sprayed with one or several gas jets, mostly compressed air, and propelled onto the prepared surface of the intermediate layer.

The inert gas arc spraying process can be used to improve the qualities of the coated resistance path. In this process, lower porosity and reduced oxidation is achieved in the layer of the coated resistance material. Entry of air in the hot gas and particle flow is prevented by a second gas flow in a protective body or by a mantle of protective gas around the arc and the spray jet. The speed of the spray jet can also be increased, in order to increase the thickness of the resistance material. Through this, the contact time of the particles of the resistance material with the sprayer and protective gas is reduced.

Ferrous metals, non-ferrous metals, conductive plastics, cermet coatings (sintered ceramic metals) etc, can be used as conductive material. Special alloys with correspondingly selected specific ohmic resistance can also be used.

The application of the conductive material can take place continually along the desired course of the conducting path. In a preferred design of the invention, for speeding up the application of material, a mask is used, which may cover the second region 5, for example, of the surface 3, on which no conductive material should be applied, so that the application of the conductive material can take place in two dimensions.

As well as the application of the conductive material of the conducting path, the periphery of the heating device can be sprayed in a thermal spraying process. Here this can concern the power supply for the conducting path, which is formed by a highly conductive material. Similarly, insulating materials can be applied with a thermal spraying process.

The electrical insulation of the heating device relative to the reflective layer of the mirror glass is done by an adhesive or an insulating varnish. The adhesive or insulating varnish here has a double function, namely, the electrical insulation on one hand, and the connection of the mirror glass with the heating element on the other hand. The reflective layer of the mirror glass, which is sensitive to mechanical strain and environmental influences, is protected by the adhesive or the insulating varnish.

The term “mirror glass” is used in connection with the present invention not only for mineral glass, but also for all possible transparent substrates, for example, of thermoplastic or thermosetting materials.

The solution according to the invention is not limited to representing logos. Any type of note or sign can be shown.

The invention has been described in an illustrative manner. It is to be understood that the terminology, which has been used, is intended to be in the nature of words of description rather than of limitation.

Many modifications and variations of the invention are possible in light of the above teachings. Therefore, within the scope of the appended claims, the invention may be practiced other than as specifically described.

I claim:

1. An exterior rear view mirror assembly for a motor vehicle having a power supply, said exterior rear view mirror assembly comprising:
a mirror bracket secured to the motor vehicle;
a mirror housing secured to said mirror bracket, said mirror housing defining a primary opening facing rearward;
a substrate movably secured within said mirror housing;
a mirror fixedly secured to said substrate and movable therewith;
a heating device having a heatable element disposed between said substrate and said mirror, said heating device having contact with the mirror, whereby said heatable element is electrically connected to electrical contacts of the power supply, wherein said heating device is divided into first and second regions, and said first and second regions are subjected to different heating output over time, wherein each of said first and second regions of said heating device includes heating cables with different cross-sections; and
a sign disposed in said second region, said sign becoming visible when said heating device begins to defrost said second region of said mirror, with the cross-sectional surfaces of the heating cables of the second region being reduced by a length, which corresponds to the diameter of the sign.

2. The exterior rear view mirror assembly according to claim 1, wherein each of said first and second regions of said heating device includes heating cables with different resistance.

3. The exterior rear view mirror assembly according to claim 1, wherein said heating element of said first and second regions is provided with power by a contact pair.

4. The exterior rear view mirror assembly according to claim 1, wherein said heating device includes a pair of heating elements, one for each of said first and second regions, each of said pair of heating elements are provided with power by several contact pairs.

5. The exterior rear view mirror assembly according to claim 1, wherein the one of the first and second regions that is defrosted first includes said sign.

6. The exterior rear view mirror assembly according to claim 1, wherein the one of the first and second regions that is defrosted last includes said sign.

7. The exterior rear view mirror assembly as set forth in claim 1 wherein said heating device is flat.

8. An exterior rear view mirror assembly for a motor vehicle having a power supply, said exterior rear view mirror assembly comprising:
a mirror bracket secured to the motor vehicle;
a mirror housing secured to said mirror bracket, said mirror housing defining a primary opening facing rearward;
a substrate movably secured within said mirror housing;
a mirror fixedly secured to said substrate and movable therewith;
a heating device having a heatable element disposed between said substrate and said mirror, said heating device having contact with the mirror, whereby said heatable element is electrically connected to electrical contacts of the power supply, wherein said heating device is divided into first and second regions, and said first and second regions are subjected to different heating output over time, wherein said heating device includes a pair of heating elements, one for each of said first and second regions, one of said pair of heating elements is provided with power with a time lag; and
a sign disposed in said second region, said sign becoming visible when said heating device begins to defrost said second region of said mirror.

9. The exterior rear view mirror assembly according to claim 8, wherein the time lag is effected by a timing element in the heating device.

10. The exterior rear view mirror assembly according to claim 8, wherein the time lag is effected by using a thermistor in the heating device.

11. An exterior rear view mirror assembly for a motor vehicle having a power supply, said exterior rear view mirror assembly comprising:
a mirror bracket secured to the motor vehicle;
a mirror housing secured to said mirror bracket, said mirror housing defining a primary opening facing rearward;
a substrate movably secured within said mirror housing;
a mirror fixedly secured to said substrate and movable therewith;
a heating device having a heatable element disposed between said substrate and said mirror, said heating device having contact with the mirror, whereby said heatable element is electrically connected to electrical contacts of the power supply, wherein said heating device is divided into first and second regions, and said first and second regions are subjected to different heating output over time, wherein each of said first and second regions of said heating device includes regional coatings with different resistances; and
a sign disposed in said second region, said sign becoming visible when said heating device begins to defrost said second region of said mirror, with the second region being exempt from the coating.

12. An exterior rear view mirror assembly for a motor vehicle having a power supply, said exterior rear view mirror assembly comprising:
a mirror bracket secured to the motor vehicle;
a mirror housing secured to said mirror bracket, said mirror housing defining a primary opening facing rearward;
a substrate movably secured within said mirror housing;
a mirror fixedly secured to said substrate and movable therewith;
a heating device having a heatable element disposed between said substrate and said mirror, said heating device having contact with the mirror, whereby said heatable element is electrically connected to electrical contacts of the power supply, wherein said heating device is divided into first and second regions, and said first and second regions are subjected to different heating output over time, wherein each of said first and second regions of said heating device includes regional coatings with one of at least differing material compositions and differing thicknesses to create different resistances, said coatings being applied by an arc spraying process, with an arc between two filamentary spraying additions of the same or different compositions being used in order to melt wire tips, the melted material being sprayed with one or several gas jets, mostly compressed air, and propelled onto the prepared surface of an intermediate layer and the speed of the spray jet being increased to increase the thickness of the resistance material in the second region; and
a sign disposed in said second region, said sign becoming visible when said heating device begins to defrost said second region of said mirror.

13. A heating device for an exterior rear view mirror, consisting of a substrate on which at least one heatable element is applied, which is in flat contact with the reflective mirror element of the exterior rear view mirror, whereby the at least one heatable element can be connected to at least two electrical contacts on a power supply, characterized in that the surface to be heated is divided over at least two regions and the at least two regions are subjected to different heating output or different temporal heat release, and whereby a sign in the second region can be represented on the surface of the reflective mirror element to be defrosted.

14. The heating device according to claim 13, characterized in that the at least two regions comprise heating wires with different resistance.

15. The heating device according to claim 13, characterized in that the at least two regions comprise heating wires with different cross-sections.

16. The heating device according to claim 13, characterized in that the heating wires of the at least two regions are provided with power by a contact pair.

17. The heating device according to claim 13, characterized in that the heating wires of the at least two regions are provided with power by several contact pairs.

18. The heating device according to claim 13, characterized in that the heating wires of the at least two regions are provided with power with a time lag.

19. The heating device according to claim 18, characterized in that the time lag is effected by a timing element in the heating circuit.

20. The heating device according to claim 18, characterized in that the time lag is effected by using a thermistor in the heating circuit.

21. The heating device according to claim 13, characterized in that the sign appears as a first defrosted region.

22. The heating device according to claim 13, characterized in that the sign remains as a non-defrosted region.
